(19) United States
(12) Patent Application Publication
(10) Pub. No.: US 2010/0167180 A1
(43) Pub. Date: Jul. 1, 2010

(54) Photosensitive Film for Holographic Recording and Production Method Thereof

(76) Inventors: Liangheng Xu, Shanghai (CN); Yun Gao, Shanghai (CN); Yang Shen, Shanghai (CN); Renshun You, Shanghai (CN)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/594,870

(22) PCT Filed: Mar. 19, 2008
(86) PCT No.: PCT/CN2008/070530

§ 371 Date: Feb. 4, 2010

(30) Foreign Application Priority Data
Apr. 6, 2007 (CN) 200710039241.7

(51) Int. Cl. G03H 1/00

(52) U.S. Cl. 430/2

(57) ABSTRACT

A photosensitive film for holographic recording and its production method thereof are disclosed. The film comprises a base film, a buffer layer coated on one side of the base film, a photosensitive polymer coating layer formed by applying a photosensitive coating on the other side of the buffer layer, and a surface protective film covering the surface of the photosensitive polymer coating layer. Interference fringe patterns of a holographic image or an amphichronic graph are recorded in the photosensitive polymer coating layer. The film according to the present invention is a photosensitive material composed of two polymers of different refractive indexes, when coherent light beams intersect in its recording medium and produce an interference fringe pattern in the medium, monomers therein are excited accordingly and undergo free radical polymerization, thereby forming a hologram.

### TECHNICAL FIELD

The present invention relates to a photosensitive material for reflection holographic recording.

### BACKGROUND ART

Three-dimensional images formed by the holographic recording technology have been widely used as anti-counterfeit labels in a wide variety of merchandises to protect against counterfeiting. They can also be used as artistic decorations, optical elements, flat display optical elements, and used in information storage technology, or the like.

A reflection hologram cannot be duplicated mechanically but only optically due to the limitation that its interference fringe patterns, which are different from those of a rainbow hologram, are largely parallel to the surface of a recording medium. Although there are a variety of materials that can be used for recording a reflection hologram, there are only a small number of ideal materials for recording and still less for mass production. The materials generally used are silver salts, dichromated gelatin and a photopolymerization material disclosed in U.S. Pat. No. 3,658,526 (Haugh). Silver salts as recording materials have a high sensitivity but a low diffraction efficiency, which can only have a diffraction efficiency of about 40% even if a dilution development method is adopted. Dichromated gelatin is a common material currently used for producing a hologram, and its diffraction efficiency may be up to 85% or more. Therefore, many holographic elements are made of this material. However, this material has many disadvantages such as low photosensitivity, short storage life, and the need of a sensitized plate that can only be made upon the time demand. In addition, after image formation, this material needs to be wet processed; therefore, the image fadeaway may easily occur in a relatively humid environment as the hologram is highly susceptible to environment. Although photopolymers, such as those material disclosed in U.S. Pat. No. 3,658,526, can overcome the disadvantages of silver salts and dichromated gelatin, they only have a limited visual response to the visible light. Because of the resolution limitation, they are limited to be used for transmission holograms, and will have very low reflection efficiency when used for reflection holograms.

### DETAILED DESCRIPTION OF INVENTION

The first technical problems solved by the present invention is to disclose a photosensitive coating A, which overcomes the disadvantages of the prior art while satisfying the needs for mass production in holographic recording technology.

The second technical problem solved by the present invention is to disclose a photosensitive polymer film material C.

The third technical problem solved by the present invention is to disclose a reflection holographic film D and a production method thereof.

The photosensitive coating A comprises a photosensitive polymer coating and a solvent; the photosensitive polymer coating contains the following ingredients in weight percents based on the total weight of the photosensitive polymer coating:
film former 20%-80%
monomers 100-70%
photoinitiator 0.5%-7%
chain transfer agent 0.3%-5%
photosensitizer 0.05%-2%.

The solid content of the photosensitive coating A is 5%-50% by weight.

The weight percents of the above ingredients are preferably as follows:
film former 30%-70%
Monomers 23.0%-60.0%
photoinitiator 2.0%-7.0%
chain transfer agent 1.0%-3.0 wt %
photosensitizer 0.5%-2.0%.

The film former is an important component which provides the system with a baseline refractive index, joins non-polymerized monomers, initiates system and related adjuvants, and furthermore, after exposed, makes significant contribution to the physical performance and refractive index modulation necessary for the formation of the reflection hologram. In order to be selected as a film former, a material must meet criteria in many aspects, including refractive index, cohesive force, adhesive force, flexibility, miscibility, and the like. The film former is selected from the group including poly(methyl methacrylate), poly(butyl cellulose acetate), a butyl cellulose acetate-ethyl vinyl ether copolymer, a blend of polyvinylbutyral and cellulose acetate, a vinyl acetate-butyl acrylate-acrylic acid terpolymer, polystyrene acrylonitrile, and a mixture of the polymers above and a fluoropolymer.

The monomers comprise two or more ethylenically unsaturated monomers, and the weight ratio of the two monomers is in the range of 0.5 to 1.8.

The ethylenically unsaturated monomers typically contain unsaturated groups at their end positions, which are capable of undergoing free radical addition polymerization, and have a boiling point above 100° C. Such ethylenically unsaturated monomers are selected from the group including vinylcarbazoles. polyfunctional ethylenically unsaturated monomers, and the like, each of winch have a high refractive index. Preferably, the monomers are selected from the group consisting of monofunctional acrylates, N-vinylcarbazoles, ethoxylated bisphenol A diacrylate, 9-(4-phenyl-2-acrylethoxy)bifluorene, and tricyclodecane dimethanol diacrylate.

The photoinitiator, the chain transfer agent, and the photosensitizer constitute a photoinitiation system, which plays a key role in determining photosensitivity of a material. The photoinitiation system contains one or more compounds that can directly produce free radicals when excited by light radiation, and the free radicals can initiate monomer polymerization.

Preferably, the photoinitiator is 2,4,6-triphenyl imidazolyl doublet.

Preferably, the photosensitizer is selected from the group including erythrosin B, diethylamino-benzylidene cyclopenpanone, michler's ketone, 1,3,3-trimethyl-2-[5-(1,3,3-trimethyl-2-indolylidene)-1,3-pentadiene]indole iodide, and the like.

Preferably, the chain transfer agent is selected from the group consisting of 2-mercaptobenzoxazole, dodecanethiol and mercaptobenzothiazole.

The photosensitive coating A farther comprises 0.5%-3% by weight of a plasticizer selected from the group including phthalate, alkyl diester, polyethylene glycol carboxylate, diethyl sebacate and the like, based on the total weight of the photosensitive polymer coating.

The photosensitive coating A further comprises 0.1%-1% by weight of a UV absorber selected from the group consisting of 2-hydroxyl-4-methoxybeezophenone and 2-(2H-Benzotriazole-2-yl)-4,6-bis(1-methyl-1-phenylethyl)phenol, based on the total weight of the photosensitive polymer coating.

The photosensitive coating A further comprises 0.1%-1% by weight of a non-ionic surfactant selected from the group consisting of polyethylene glycol, methoxy polyethylene glycol, and fluoro-containing surfacant Fluorad® FC-4430 (CAS No. 108-88-3, 3M Company) to adjust the performance of the coating, based on the total weight of the photosensitive polymer coating.

The solvent is preferably a mixed solvent of butanone, dichloromethane and methanol in a weight ratio of 4-6:0.5-1.5:0.5-1.5, preferably in a ratio of 5:1:1.

The photosensitive polymer film material C of the present invention comprises a base film, a buffer layer coated on one side of the base film, a photosensitive polymer coating layer farmed by applying the photosensitive polymer coating on the other side of the buffer layer, and a surface protective film covering the surface of the photosensitive polymer coating layer; the photosensitive polymer coating layer, when dried, has a thickness of 3-50 μm.

The buffer layer, which is a connection layer between the photosensitive polymer coating layer and the base film, may be made of a copolymer of vinyl acetate and acrylates, or a vinylidene chloride-styrene-vinyl acetate copolymer, both of which have a refractive index similar to the base film; alternatively, it may be made of a light-cured coating. The buffer layer has a thickness of 1-2 μm.

The surface protective film may be a film having a release coating, preferably a PET film that is 16-23 μm thick. Such a PET film, BOPP film, and PE or PVC film having a release coating are commercially available.

The base film may be a PVC, PET or BOPP film of 20-100 μm thickness.

The reflection holographic film D comprises a base film, a buffer layer coated on one side of the base film, and a photosensitive polymer coating layer formed by applying the photosensitive polymer coating on the other side of the buffer layer. Interference fringes of a holographic image or amphichronic graph are recorded in the photosensitive polymer coating layer. The recording layer has a thickness of 3-50 μm. The base film may be a PVC, PET or BOPP film.

The method for producing the holographic photosensitive film D comprises the following steps:

(1) Preparation of the Coating Material:

a film former, monomers, an initiator, a photosensitizer, a plasticizer and a surfactant are added to a solvent in a proportion under a light-proof condition or red light, and are dissolved by stirring to obtain the photosensitive coating A:

(2) Preparation of the Film,

a vinyl acetate-acrylate copolymer or a vinylidene chloride-styrene-vinyl acetate copolymer is coated on the base film as a buffer layer with a thickness of 1-2 μm,

the photosensitive coating A obtained from the previous step is then applied to the base film having the buffer layer under a light-proof condition or red light, and the base film with a thickness of 20-100 μm is then dried at 65-75° C. for 1-5 minutes to obtain a photosensitive holographic film material that is 20-50 μm thick. This photosensitive holographic film material is finally dried and covered with a protective film, thus obtaining the photosensitive polymer film material C;

(3) Preparation of the Reflection Holographic Film D,

the protective film is removed from the product obtained from the previous step and a hologram is recorded onto the photosensitive polymer film material C by a reflection holographic recording process;

this film is then exposed to UV and visible light for a completed exposure on a UV curing machine and then heated at 120° C. for 2-50 minutes, thereby obtaining the reflection holographic film D, which is a solid transparent film material having a certain of flexibility.

The wavelength of the aforementioned red light should be greater than 600 nm. The purpose of using a light-proof condition or red light is to prevent the sensitive coating material A from being exposed to light.

The laser source has a wavelength of 514.5 nm or 532 nm, a light intensity of 60-110 mw/cm², and the exposure time is 0.1-1.0 s. The laser source may be generated by an argon ion laser (wavelength: 514 nm) or a semiconductor solid laser (wavelength: 532 nm).

The laser recording method is a conventional, technique based on general principles of holographic optical recording, and those skilled in the art can carry out this method by reference.

The photosensitive polymer film according to the present invention is a photosensitive material using two polymers of different refractive indexes, when two coherent beams as reference beam and object beam intersect in its recording medium from opposite sides (or the same side) and produce an interference fringe pattern in the medium, monomers therein are excited accordingly and undergo free radical polymerization, thereby forming a hologram and obtaining a holographic image with high diffraction efficiency.

In the present invention, alternating bright and dark reflection fringes of a specific wavelength are formed in the photosensitive holographic polymer material according to the optical interference principle. Photopolymerization is a process in which free radicals generated by a photochemical method initiate monomer polymerization. When subjected to radiation from a light with specific wavelength, the photoinitiation system absorbs photons and transits to an excited state, thereby transfers photoinitiator energy to generate free radicals and initiates monomers polymerization. The polymerization takes places at the bright region, which causes the monomers at the dark region to migrate to the bright region where the monomers become scarce. Accordingly, polymers with refractive indexes different from that of the film former are formed according to the reflection fringe pattern, thereby obtaining a hologram with bright appearance.

In view of the above embodiments, the photosensitive holographic film of the present invention has a good sensitivity, a high reflection efficiency and a long storage life, and the hologram recorded therein is not greatly susceptible to environment. Contrast to the conventional wet-process of photosensitive material, the recorded image obtained according to the present invention simply need photo-curing and thermal enhancement processes to achieve a reflection holographic image or amphichronic graph with refraction efficiency greater than 95%, thus is suitable for mass production.

### BRIEF DESCRIPTION OF THE DRAWINGS

FIG. 1 is a schematic view showing the structure of a photosensitive polymer film;

FIG. 2 is a schematic view showing the recording and optical test of a reflection hologram.

### DETAILED DESCRIPTION OF EMBODIMENTS

Hereinafter, the present invention will be illustrated by reference of examples which should be construed as exemplary and do not intend to limit the invention in any way.

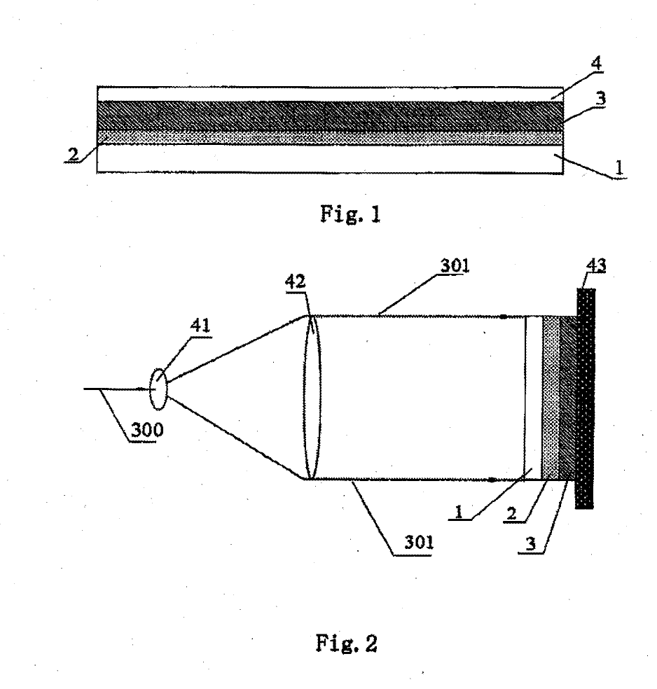

FIG. 1 shows a base film 1 of the photosensitive polymer film of the present invention, a buffer layer 2 coated on one side of the base film 1, a photosensitive polymer coating layer 3 coated on the other side of the buffer layer 2. Interference fringe patterns of a hologram or a variable bicolor pattern are recorded onto the photosensitive polymer coating layer 3.

### Example 1

Under a red safelamp with a wavelength of greater than 600 nm, 6 g (67.3 wt %) of polyvinyl acetate-butyl acrylate-acrylic acid terpolymer as a film former, 1.2 g (13.5 wt %) of N-vinylcarbazole as one monomer, 1.0 g (11.2 wt %) of a tricyclodecane dimethanol diacrylate as another monomer, 0.2 g (2.2 wt %) of 2,4,6-triplienyl imidazolyl doublet as a photoinitiator, 0.05 g (0.57%) of diethylamine-benzylidene cyclopenpanone as a photosensitizer, 0.15 g (1.68 wt %) of 2-merceptobenzathiazole as a chain transfer agent, 0.05 g (0.56 wt %) of 2-hydroxyl-4-methoxybenzophenone as a UV absorber, 0.06 g (0.67 wt %) of Fluorad® FC-4430 as a non-ionic surfactant, and 0.2 g (2.2 wt %) of diethyl sebacate as a plasticizer, were added to a mixed solution (butanone:dichloromethane:methanol, in a weight ratio of 5:1:1). The solution had a solid content of 10% by weight, and was stirred at room temperature to dissolve. The viscosity measured was 10-12 cp (25° C.). The solution was filtrated to obtain a photosensitive coating A, stored for later use.

A 50 μm thick, highly transparent PET film was used as a base film (1). A solution of vinylidene chloride-styrene-vinyl acetate copolymer was prepared at a weight concentration of 40%. The solution was applied to the base film (1) by using a 120-line anilox roller and dried at 60° C. to obtain a buffer layer (2) with a thickness of 1-2 μm.

Adjusting the gap between the blade and the coating head to 200 μm, the photosensitive coating A obtained from previous step was applied to the PET film with a thickness of 50 μm that had been coated with the buffer layer (2). The film overlied by the coating was then dried at 75° C. in a convection drying oven. The final coating layer was 10 μm thick and was then covered with a 23 μm thick PET film having a release coating, thereby obtaining a photosensitive polymer film C.

Preparation of a Reflection Holographic Film D:

An “on-axis” reflection holographic recording method as shown in the FIG. 2 was adopted. Cutting the holographic photosensitive polymer film C into 30×30 mm sheets. The sheet was evenly adhered to a reflecting mirror (43) after removal of the surface protective film (4). A laser beam (300) of an argon ion laser (514 nm) passed through a beam expander (41) equipped with a pinhole filter and through an aspherical collimating lens (42) to form parallel beam (301) that had a light intensity of 60 mw/cm² and irradiated the photosensitive polymer film C. The parallel beam (301) entered from the base film (1), passed through the buffer layer (2) and the photosensitive coating A layer (3), and reached the reflecting mirror (43). The exposure time was 0.1 s, a hologram was therefore recorded on the photosensitive polymer film C, which was then subjected to a completed exposure to UV and visible lights on a UV curing machine and was subsequently heated at 120° C. for 2 minutes, finally obtaining the reflection holographic film D which was visually a holographic reflecting mirror. The film was a solid transparent film material with a certain of flexibility.

### Example 2

Under a red safelamp with a wavelength of greater than 600 nm, 2.5 g (30.5 wt %) of a blend of polyvinylbutyral and cellulose acetate as a film former, 2.8 g (34.1 wt %) of N-vinylcarbazole as one monomer, 1.7 g (20.7 wt %) of ethoxylated bisphertol A diaerylate as another monomer, 0.54 g (6.6 wt %) of benzoin isobutyl ether as a photoinitiator, 0.12 g (1.46 wt %) of Michler's ketone as a photosensitizer, 0.23 g (2.8 wt %) of 2-meroaptobenzothiazole as a chain transfer agent, 0.06 g (0.73 wt %) of 2-hyciroxyl-4-methoxybenzophenone as a UV absorber, 0.06 g (0.73 wt %) of methoxy polyethylene glycol as a non-ionic surfactant, and 0.2 g (2.4 wt %) of diethyl sebacate as a plasticizer, were added into a mixed solution (butanone:dichloromethane:methanol, in a weight ratio of 5:1:1). The solution has a solid content of 32.4% by weight, and was stirred at room temperature to dissolve. The viscosity measured was 28.3 cp (25° C.). The solution was filtrated to obtain a photosensitive coating A, stored for later use.

A 36 μm thick, highly transparent PET film was used as a base film (1). A solution of the vinyl acetate-butyl acrylate copolymer was prepared at a weight concentration of 30%. The solution was then applied to the base film (1) by using a 100-line anilox roller and dried in an oven at 50-70° C. to obtain the base film with a 1-2 μm thick buffer layer (2).

Adjusting the gap between the blade and the coating head to 180 μm, the photosensitive coating A was applied to the 30 μm thick PET film that had been coated with the buffer layer (2). The film overlied by the coating was dried at 75° C. in a convection drying oven. The coating layer was 10 μm thick and was then covered with a 16 μm thick aluminum-plated PET film, thereby obtaining a photosensitive polymer film C.

A reflection holographic recording method as shown in the FIG. 2 was adopted. The reflecting mirror (43) in FIG. 2 was replaced by an aluminum-plated PET film. The photosensitive polymer film C obtained from the previous step was fixed onto a flat glass. A semiconductor solid laser, 532 nm, was used as the recording light source (300), and the parallel light beam (301) was formed by a beam expander (41) equipped with a pinhole filter and a non-spherical collimating lens (42). The light intensity was 100 raw/cm² and irradiated the photosensitive polymer film C fixed on the flat glass. The parallel beam (301) entered from the base film (1), passed through the buffer layer (2) and the photosensitive coating A layer (3), reached the aluminum-plated PET film, and was reflected back along the original path to the photosensitive layer to produce a reflection film. The reflection film had an area of 50×50 mm and a light intensity of 100 mw/cm². The reflecting film appeared green when viewed at certain angle and blue when the viewing angle changed.

### Example 3

The evaluation of the photosensitive polymer film C could be performed by reference to the method as shown in FIG. 2, and hologram was recorded on the photosensitive polymer film by coherent light through an “on-axis” recording technique.

The photosensitive polymer film C was cut into 30×30 mm sheets. The sheet was evenly adhered to a reflecting mirror (43) after removal of the surface protection film (4). An argon ion laser (514 nm) was used as a light source, and a light beam (300) passed through a beam expander (41) equipped with a pinhole filter and through an aspherical collimating lens (42) to form parallel light beam (301) that irradiated the photosensitive polymer film C. The parallel hen (301) entered from the base film (1), passed through the buffer layer (2) and the photosensitive coating A layer (3), reached the reflecting mirror (43), and then was reflected back along the original path to the photosensitive coating A layer (3) to produce a recording grating. The diameter of irradiation was 15 mm. Under the same light intensity, the reflection gratings at different exposure times were recorded, respectively. Following the recordings, the film materials were cured by a high-pressure mercury lamp. A S-53 UV-visible light spectrophotometer was used for measurement. Setting the transmittance at a position free of reflection gratings to be I_{Q}, and measuring the minimum transmittance I attic reflection plate at every different exposure time and the wavelength λ at the spot, it was found that after holographic recording the wavelength λ=512 nm. By using the equation η=1−I/I₀, it was calculated that the maximum refraction efficiency η=75% and the refractive index modulation=0.0153. The tested flint materiels were then placed in a convection drying oven and heated for 2-8 minutes at 115° C. They were then tested again by the same method as mentioned above, and it was shown that, by data comparison, the materials had a sensitivity of 20.3 mj/cm², a wavelength λ=509 nm, a maximum refraction efficiency η=99.5%, and a refraction index modulation=0.0543. These test results showed that before the heat treatment, for the purpose of recording reflection grating, the materials already had a reflection efficiency of up to 75%, and this refraction efficiency rose to 99.5% after the heat treatment. This dry process could absolutely satisfy the requirements for the treatment of the materials. The materials thus treated were subjected to acid/base and humidifying treatments, and the image did not fade away.

1. A photosensitive coating A comprising a photosensitive polymer coating and a solvent, wherein the photosensitive polymer coating contains the following ingredients in weight percents based on the total weight of the photosensitive polymer coating:
film former 20%-80%
monomers 10%-70%
photoinitiator 0.5%-7%
chain transfer agent 0.3%-5%
photosensitizer 0.05-2%
wherein the film former is selected from the group consisting of poly(methyl methacrylate), poly(butyl cellulose acetate), a butyl cellulose acetate-ethyl vinyl ether copolymer, a blend of polyvinyl butyral and cellulose acetate, a vinyl acetate-butyl acrylate-acrylic acid terpolymer, polystyrene-acrylonitrile, and a mixture of the polymers above and a fluoropolymer;
the monomers are two or more monomers selected from ethylenically unsaturated monomers; and
the photoinitiator is 2,4,6-triphenyl imidazolyl dimer, and;
the photosensitizer is selected from the group consisting of erythrosin B, diethylamino-benzylidene cyclopenpanone, michler's ketone, and 1,3,3-trimethyl-2-[5-(1,3,3-trimethyl-2-indolylidene)-1,3-pentadiene]indole iodide; and
the chain transfer agent is selected from the group consisting of 2-mercaptobenzoxazole, dodecanethiol and mercaptobenzothiazole.

2. The photosensitive coating A according to claim 1, wherein the solid content of the photosensitive coating A is 5%-50% by weight.

3. The photosensitive coating A according to claim 1, wherein the weight percents of ingredients are preferably as follows:
film former 30%-70%
monomers 23.0%-60.0%
photoinitiator 2.0%-7.0%
chain transfer agent 1.0%-3.0%
photosensitizer 0.5%-2.0%

4. The photosensitive coating A according to claim 1, further comprising 0.5%-3% of a plasticizer based on the total weight of the photosensitive polymer coating, the plasticizer being selected from the group consisting of phthalate, alkyl diester, polyethylene glycol carboxylate and diethyl sebacate.

5. The photosensitive coating A according to claim 4, further comprising 0.1% -1% of a UV absorber based on the total weight of the photosensitive polymer coating, the UV absorber based on the total wight of the photosensitive polymer coating, the UV absorber being selected from the group consisting of 2-hydroxyl-4-methoxybenzophenone and 2-(2H-Benzotriazole-2-yl)-4,6-bis(1-methyl-1-phenylethyl)phenol.

6. The photosensitive coating A according to claim 5, further comprising 0.1%-1% of a non-ionic surfactant based on the total wight of the photosensitive polymer coaing, the non-ionic surfactant being selected from the group consisting of polyethylene glycol, methoxy polyethylene glycol, and Fluroad® FC-4430 (CAS No. 108-88-3).

7. The photosensitive coating A according to claim 1, wherein the solvent is mixed solvent of butanone, dichloromethane, and methanol in a weight ration of 4-6:0.5-1.5:0.5-1.5.

8. The photosensitive coating A according to claim 7, wherein the solvent is a mixed solvent of butanone, dichloromethane, and methanol in a weight ration of 5:1:1.

9. The photosensitive coating material A according to claim 1, wherein the weight ratio of the two monomers is in the range of 0.5-1.8.

10. The photosensitive coating material A according to claim 1, wherein the monomers are selected from the group consisting of monofunctional acrylates, N-vinylcarbazoles, ethoxylated bisphenol A diacrylate, 9-(4-phenyl-2-acrylethoxy)bifluorene and tricyclodecane dimethanol diacrylate.

11. A photosensitive polymer film material C, comprising: a base film, a buffer layer coated on one side of the base film, a photosensitive polymer coating layer formed by applying the photosensitive polymer coating as recited in claim 1 on the other side of the buffer layer, and a surface protective film covering the surface of the photosensitive polymer coating layer.

12. The photosensitive polymer film material C according to claim 11, wherein the photosensitive polymer coating, when dried, has a thickness of 3-50 μm.

13. The photosensitive polymer film material C according to claim 11, wherein the buffer layer comprises a copolymer of vinyl acetate and acrylates, a vinylidene choloride-styrene-vinyl acetate copolymer, or a light-cured coating layer, and having a thickness of 1-2 μm.

14. The photosensitive polymer film material C according to claim 11, wherein the surface protective film is selected from a group consisting of a PET film, a BOPP film, and a PE PVC film, each of which having a release coating layer, and the base film is selected from a group consisting of a PVC film, a PET film, and a BOPP film, and having a thickness of 20-100 μm.

15. A reflection holographic film D, comprising a base film, a buffer layer coated on one side of the base film, and a photosensitive polymer coating layer formed by applying the photosensitive polymer coating as recited in claim 1 on the other side of the buffer layer, wherein interference fringe patterns of a holographic image or amphichronic graph are recorded onto the photosensitive polymer coating layer.

16. The reflection holographic film D according to claim 15, wherein the recording layer has a thickness of 3-50 μm.

17. The reflection holographic film D according to claim 15, wherein the base film is selected from a group consisting of a PVC film, a PET film, and a BOPP film.

18. A method for producing the holographic photosensitive film D according to claim 15, comprising the steps of:
1) preparation of the coating material, wherein a film former, monomers, an initiator, a photosensitizer, a plasticizer and a surfactant are added to a solvent in a proportion under a light-proof condition or red light, dissolved by stirring to obtain the photosensitive coating A;
2) preparation of the film, wherein a layer with a thickness of 1-2 μm, composed of a copolymer of vinyl acetate and acrylates, or a vinylidene chloride-stryrene-vinyl acetate copolymer, is coated on the base film as a buffer layer; and the photosensitive coating A obtained from the previous step is applied onto the base film having the buffer layer under a light-proof condition or red light; and
the base film with a thickness of 20-100 μm is dried at 65-75° C. for 1-5 minutes to obtain a 20-50 μm thick photosensitive holographic material; and
the photosensitive holographic material is then dried and covered with a protective film, thereby obtaining the photosensitive polymer film material C;
3) preparation of the reflection holographic film D:
The protective film is removed from the product obtained from the previous step, and a hologram is recorded onto the photosensitive polymer film material C by a reflection holographic recording process;
the film is exposed to UV and visible light for a completed exposure on a UV curing machine and is heated at 120° C. for 2-50 minutes, thereby obtaining the reflection holographic film D.

19. The method according to claim 18, wherein the wavelength of red light should be greater than 600 nm.

20. The method according to claim 18, wherein a laser source has a wavelength of 514.5 nm or 532 nm, a light intensity of 60-110 mw/cm², and the exposure time is 0.1-1.0 s.

21. The method according to claim 18, wherein the laser source is generated by an argon ion laser or a semiconductor solid laser.
